(19) United States
(12) Patent Application Publication
(10) Pub. No.: US 2004/0174623 A1
(43) Pub. Date: Sep. 9, 2004

(54) Opaque see-through non-reflective convex mirror

(76) Inventor: Steve Weinreich, Monmouth Jct., NJ (US)

Correspondence Address: STEPHEN WEINREICH, 14 NORTON RD, MONMOUTH JUNCTION, NJ, 08852, US

(21) Appl. No.: 10/800,104

(22) Filed: Mar. 12, 2004

Related U.S. Application Data
(63) Continuation-in-part of application No. 09/624,483, filed on Jul. 24, 2000, now Pat. No. 6,705,740.

(51) Int. Cl. G01V 8/00

(52) U.S. Cl. 359/839

(57) ABSTRACT

A perforated convex mirror with a non-specular concave face, being partially transparent and partially reflective, acts like a lightly silvered mirror, but it's concave face does not focus collimated light.

This Invention is related to my previous work expressed in U.S. Pat. No. 4,971,312, ILLUSION. APPARATUS, U.S. Pat. No. 5,681,223, TRAINING VIDEO METHOD AND DISPLAY, U.S. Pat. No. 5,871,404, OPTICAL BLOB, and U.S. Pat. No. 6,705,740, TRACKING MIRROR (to be issued Mar. 16, 2004), the contents of each being here incorporated by reference thereto.

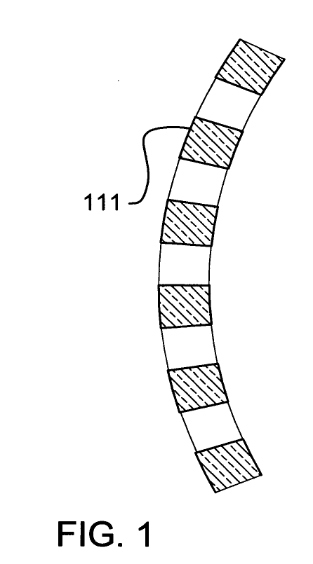

The preferred mirror is shown in section in FIG. 1.

As stated in U.S. Pat. No. 6,705,740, “the mirror itself may be formed from polished metal such as stainless steel, well known in some security mirror products. It is however required that the mirror be partially transparent. The mirror 111 is, therefore, formed from perforated stock or may be perforated as part of the forming process (by punching) or after forming (as by drilling).

“Such a mirror 111 can be painted (or otherwise finished) matte black on its concave side to suppress unwanted reflections. This is a valuable structure for many uses of the diverse embodiments of the present Invention and of the other Patents incorporated herein by reference. Not only are miscellaneous reflections suppressed, but the ability of the concave side to focus collimated light is obviated. Mirrors of diverse materials can be manufactured by ordinary means to take advantage of these benefits of perforated mirrors.”

Plastic mirrors can, for example, be cast with perforations.

Although preferred, it is not necessary for the concave side to be black in order to be useful. To accomplish the purpose of suppressing the ability of the mirror to focus light to a hot spot, almost anything but a specular concave surface is useful. Miscellaneous reflections may also be substantially suppressed with even a white surface.

The mirror may be optically, rather than physically perforated, as by coating, by means well known in the art, a single surface of a transparent substrate with preferably two layers, one being a specular coating, the other non-specular. The coatings are preferably applied on the concave side of the substrate, the specular coating being applied first.

Optical perforations can be formed by applying a resist, such as is known in the art, to the substrate prior to coating or by removing portions of the coating. The resist can be applied in a useful pattern by screen-printing, spraying, or by other ordinary means. Coating removal can be accomplished with known solvents.

It is also possible to apply perforated, including optically perforated, thin films to transparent substrates, before or after forming.

The size and spacing of perforations are determined with reference to the specific requirements of the application. Most useful embodiments will employ staggered rows of circular perforations, the perforations taking up fifty percent, more or less, of the mirror area. The perforation size is preferably near the limit of visual acuity (ordinarily one minute) for a viewer at the design distance.

While the Invention has been described with reference to preferred embodiments thereof. it will be appreciated by those of ordinary skill in the art that modifications can be made to the Invention and to its uses without departing from the spirit and scope thereof.

I claim:

1. A perforated convex mirror.

2. The mirror of claim 1, wherein the perforations are physical.

3. The mirror of claim 1, wherein the perforations are optical.

4. The mirror of claim 1, wherein the concave side of the mirror is non-specular.

5. The mirror of claim 1, wherein the concave side of the mirror is black.
